(19) United States
(12) Patent Application Publication
(10) Pub. No.: US 2024/0311650 A1
(43) Pub. Date: Sep. 19, 2024

(54) TECHNOLOGIES FOR USING MACHINE LEARNING MODELS TO ASSESS TIME SERIES DATA

(71) Applicant: MCKINSEY & COMPANY, INC., New York, NY (US)

(72) Inventors: Sohrab Rahimi, Summit, NJ (US); Nicolai von Bismarck, Boston, MA (US); Zhekun Xiong, Boston, MA (US); John Lint, New York, NY (US); Celso Luiz Barroso de Moraes, São Paulo (BR)

(21) Appl. No.: 18/120,895

(22) Filed: Mar. 13, 2023

(51) Int. Cl. G06N 3/0985

(52) U.S. Cl. CPC G06N 3/0985

(57) ABSTRACT

Systems and methods for using machine learning for time series forecasting are disclosed. According to certain aspects, a set of time series data may be prepared and a plurality of features extracted therefrom. A feature vector based on the plurality of features may be generated and input into a classifier model to assess how well each of a plurality of available machine learning models is equipped to analyze the set of time series data and output a time series forecast. In embodiments, a stacking machine learning model may improve the time series forecast by accounting for multiple machine learning models as well as a set of covariates.

### FIELD

The present disclosure is directed to improvements related to time series forecasting. More particularly, the present disclosure is directed to platforms and technologies for using machine learning to ascertain how to analyze time series data to make future time series predictions in an efficient and accurate manner.

### BACKGROUND

Artificial intelligence (AI) and machine learning (ML) techniques are increasingly being used for a variety of applications. For example, generative AI is used to generate text and/or images based on inputted prompts. Further, text analysis and text understanding is used for summarizing, captioning, and extracting sentiment in writing. One area of data science research for which ML has not been effective, however, is time series forecasting.

Generally, time series forecasting is the use of statistical models to predict future values of a time-dependent variable based on its historical values. From financial modeling to healthcare analysis, time series data generally has an incredible diversity of characteristics and features, causing it to be impossible to find a one-fits-all solution for this type of forecasting. Current regressive and auto regressive models are being used to analyze time series data, but testing all of them in a brute force manner can be unviable depending on deployment deadlines and other time constraints. Additionally, generally using machine learning for time series forecasting is difficult because, among other reasons, time series data is dependent on past values, time series data is often non-stationary and/or limited, time series data often exhibits seasonal patterns and trends, different machine learning models have strengths and weaknesses, and machine learning models often overfit to the training data and have several hyperparameters that need to be tuned to achieve optimal performance, among other challenges.

Accordingly, there is an opportunity for platforms and technologies to employ machine learning model selection and usage for time series forecasting.

### SUMMARY

In an embodiment, a computer-implemented method of using machine learning for time series forecasting is provided. The computer-implemented method may include: preparing, by one or more processors, a set of time series data; extracting, by the one or more processors, a plurality of features from the set of time series data that was prepared; generating, by the one or more processors, a feature vector based on the plurality of features that were extracted; and inputting, by the one or more processors, the feature vector into a classifier model to assess how well each of a plurality of available machine learning models is equipped to analyze the set of time series data.

In another embodiment, a system for using machine learning for time series forecasting is provided. The system may include a memory storing a set of computer-readable instructions and data associated with a classifier model and a plurality of available machine learning models, and one or more processors interfaced with the memory, and configured to execute the set of computer-readable instructions to cause the one or more processors to: prepare a set of time series data, extract a plurality of features from the set of time series data that was prepared, generate a feature vector based on the plurality of features that were extracted, and input the feature vector into a classifier model to assess how well each of the plurality of available machine learning models is equipped to analyze the set of time series data.

Further, in an embodiment, a non-transitory computer-readable storage medium configured to store instructions executable by one or more processors is provided. The instructions may include: instructions for preparing a set of time series data; instructions for extracting a plurality of features from the set of time series data that was prepared; instructions for generating a feature vector based on the plurality of features that were extracted; and instructions for inputting the feature vector into a classifier model to assess how well each of a plurality of available machine learning models is equipped to analyze the set of time series data.

### BRIEF DESCRIPTION OF THE FIGURES

FIG. 1A depicts an overview of components and entities associated with the systems and methods, in accordance with some embodiments.

FIG. 1B depicts an overview of certain components configured to facilitate the systems and methods, in accordance with some embodiments.

FIG. 2 depicts an overview of components associated with automated machine learning selection, in accordance with some embodiments.

FIG. 3 depicts a correlation table indicating results of time series data testing by a plurality of machine learning models, in accordance with some embodiments.

FIG. 4 illustrates a diagram of functionalities associated with training an automated machine learning selection model, in accordance with some embodiments.

FIG. 5 illustrates an overview of components and functionalities for using machine learning to perform time series forecasting, in accordance with some embodiments.

FIG. 6 illustrates a diagram associated with stacking functionality, in accordance with some embodiments.

FIG. 7 is a block diagram illustrating an example method of using machine learning for time series forecasting, in accordance with some embodiments.

FIG. 8 is an example hardware diagram of an electronic device and a server configured to perform various functionalities, in accordance with some embodiments.

### DETAILED DESCRIPTION

The present embodiments may relate to, inter alia, using machine learning to assess time series data and perform time series forecasting. According to certain aspects, an automated machine learning model approach (AutoML) is provided to circumvent existing time constraints and use intrinsic characteristics of each time series data to find the best possible machine learning model to assess each input dataset.

One of the main goals of time series forecasting is to use past observations of a given target variable, with the option of adding existing extrinsic features to better understand the state space of each output, to predict values in future data times. The main difficulties of this task are the wide variety of types, characteristics, and behavior present in time series data, which may make it impossible to create a complex machine learning model that is able to work well for certain applications. Most noticeable variation occurs in the possible trend strengths, seasonality behaviors, and volatility of outputs that can be present in different signals. Some even closely resemble Brownian motion and white noise data. Due to this great variation in behavior, dedicated linear models that aim at specifically targeting different features of time series data are conventionally employed. Deep learning options have also been created to enhance the performance of forecasting in this space, the majority of them using some form of recurrent neural network as their main building block.

However, for predictions to work properly, a great amount of data is needed, which for certain types of timeseries might be unviable or even impossible to obtain. A current approach to ensure an adequate-performing forecast is to try to run data in a range of different models, with the hopes that one of them might perform well enough to be used in an application. However, this solution might not be viable for time-constrained projects, where delivering a quick solution for data that can reach gigabytes of size, and span over thousands of time intervals, might be necessary. Further, the amount of available computational resources may limit the ability to search through multiple different models. Therefore, a more efficient method to better assess which model should be used for forecasting is necessary.

AutoML is used in various kinds of applications, ranging from automated processes for data preparation and feature selection, to more complex approaches such as meta-learning and neural architecture search, where the very connections of perceptrons in fully connected layers can be changed depending on the inputs and the difference in distribution of the data for a new task to be performed.

For time series analysis, AutoML has focused on performing hyperparameter selection for an already-chosen model type by applying one or more methodologies. In particular, grid search is a brute force approach where a set of possible parameters is previously defined to try for the model configuration, and in the end compare the best results which will be chosen as the values to be used in the final version of the model. Alternatively, random search is a similar brute force approach where the parameters are chosen and varied at random, with the goal to combine exploration and exploitation to find better fitting parameters for the model. This option may reduce human bias since the values to be used are chosen at random. Further, Bayesian optimization is a more optimized search where it uses the results of the previous hyperparameters to better chose the values to be used in the next iteration. Moreover, genetic algorithms is a type of evolutionary algorithm which also uses previous results from hyperparameters to better choose the values of the next iterations, performing biologically-inspired actions such as crossover, mutation, and selection of different subgroups.

As effective as these methodologies might be for finding the best possible hyperparameters for each model configuration, these methodologies still rely on running the model a large number of times, which is often impossible, causing default and pre-specified values to be used instead. Further, in all of these approaches, it is assumed that a certain type of model was previously chosen to be used, which is in itself a problem that also needs to be optimized.

According to the present embodiments, systems and methods that extract a feature(s) from time series data and uses it to feed a classification model that will be responsible for choosing the best model out of a possible search space for that data input in particular, are provided. These systems and method improve on existing technologies because they circumvent time constraints and use intrinsic characteristics of time series datasets to assess the best possible machine learning model to use for assessing the time series datasets. Further, the systems and methods result in greater accuracy as well as greatly reduce the amount of time needed, from training to deployment, in a real-world scenario. Additionally, the training and use of the machine learning model(s) enables the systems and methods to process large datasets that conventional systems are unable to analyze as a whole. This results in improved processing time by the systems and methods. Moreover, by virtue of employing the trained machine learning model(s) in its analyses, the systems and methods reduce the overall amount of data retrieval and communication necessary for the analyses of time series datasets, reducing traffic bandwidth and resulting in cost savings.

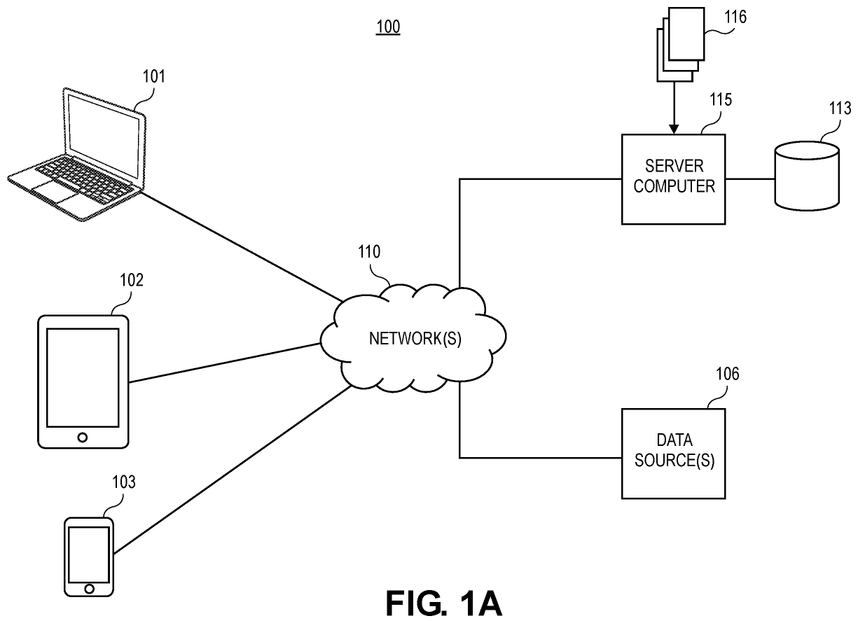

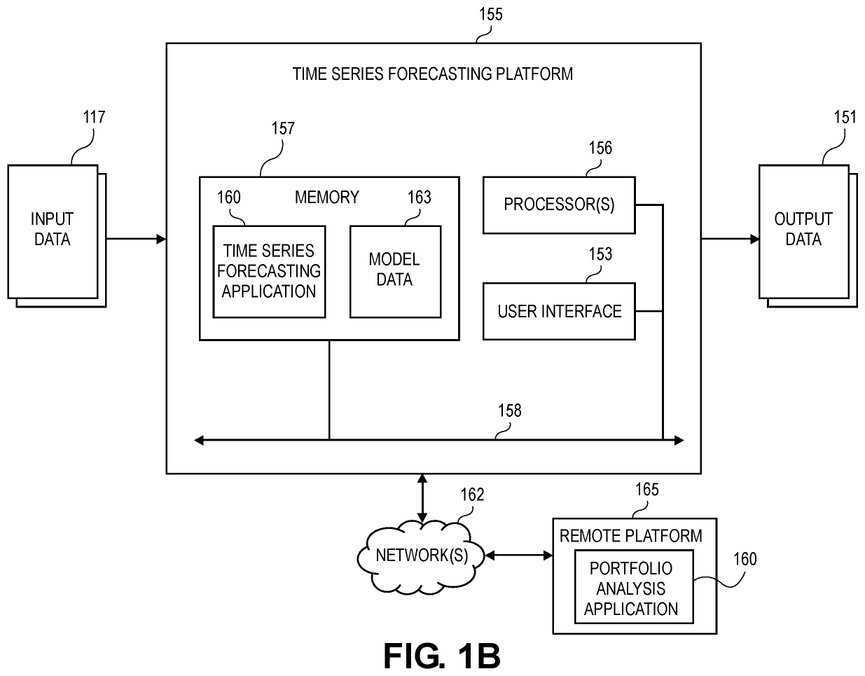

FIG. 1A illustrates an overview of a system 100 of components configured to facilitate the systems and methods. It should be appreciated that the system 100 is merely an example and that alternative or additional components are envisioned.

As illustrated in FIG. 1A, the system 100 may include a set of electronic devices 101, 102, 103. Each of the electronic devices 101, 102, 103 may be any type of electronic device such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like. In embodiments, any of the electronic devices 101, 102, 103 may be an electronic device associated with an individual or an entity such as a company, business, corporation, or the like (e.g., a server computer or machine).

The electronic devices 101, 102, 103 may communicate with a server computer 115 via one or more networks 110. In embodiments, the network(s) 110 may support any type of data communication via any standard or technology (e.g., GSM, CDMA, VoIP, TDMA, WCDMA, LTE, EDGE, OFDM, GPRS, EV-DO, UWB, Internet, IEEE 802 including Ethernet, WiMAX, Wi-Fi, Bluetooth, 4G/5G/6G, Edge, and others). The server computer 115 may be associated with an entity such as a company, business, corporation, or the like (generally, a company) that may be interested in time series forecasting. The server computer 115 may include various components that support communication with the electronic devices 101, 102, 103.

The server computer 115 may communicate with one or more data sources 106 via the network(s) 110. In embodiments, the data source(s) 106 may compile, store, or otherwise access information associated with time series forecasting and associated time series data. For example, time series forecasting may be useful in finance (e.g., to predict stock prices, exchange rates, and interest rates, and to forecast demand for financial products and services), retail (e.g., to predict demand for products, optimize inventory levels, plan marketing campaigns, forecast sales trends and seasonal fluctuations), energy (e.g., to predict energy demand and supply, optimize energy production, and manage energy storage systems), healthcare (e.g., to predict patient volumes, optimize staffing levels, and forecast disease outbreaks), transportation (e.g., to predict traffic patterns, optimize transportation routes, and forecast demand for transportation services), weather (e.g., to predict weather patterns, including temperature, precipitation, and wind speed, which may impact agriculture, energy, and transportation), manufacturing (e.g., to predict demand for products, optimize production schedules, and manage inventory levels), and social media (e.g., to predict trends and patterns in social media activity, including the volume of posts, sentiment analysis, and topic modeling, which may be used for marketing, advertising, and reputation management purposes). It should be appreciated that alternative and additional data sources are envisioned.

The server computer 115 may analyze this data according to the functionalities as described herein, which may result in a set of training datasets 116. In some implementations, the server computer 115 may access the raw data or information (and/or the training dataset(s) 116) from one or more of the electronic devices 101, 102, 103. The server computer 115 may receive, access, or generate the training dataset(s) 116, and may employ various machine learning techniques, calculations, algorithms, and the like to train a set of machine learning models using the training dataset(s) 116.

According to embodiments, the server computer 115 may train and test a set of machine learning models with a set of training time series data to assess how each of the set of machine learning models performs with the set of training time series data. Further, in embodiments, the server computer 115 may analyze a given input set of time series data with another machine learning model to assess how each of the trained set of machine learning models would perform with the given input set of time series data, where each of the trained set of machine learning models may output a respective forecast time series. A user of the electronic devices 101, 102, 103 (e.g., an individual performing time series forecasting) may review the result(s) or output(s) and use the information for various purposes. In embodiments, a user may access the result(s) or output(s) directly from the server computer 115.

The server computer 115 may be configured to interface with or support a memory or storage 113 capable of storing various data, such as in one or more databases or other forms of storage. According to embodiments, the storage 113 may store data or information associated with the machine learning models that are trained and used by the server computer 115. Additionally, the server computer 115 may access the data associated with the stored machine learning models to input a set of inputs into the machine learning models.

Although depicted as a single server computer 115 in FIG. 1A, it should be appreciated that the server computer 115 may be in the form of a distributed cluster of computers, servers, machines, cloud-based services, or the like. In this implementation, the entity may utilize the distributed server computer(s) 115 as part of an on-demand cloud computing platform. Accordingly, when the electronic devices 101, 102, 103 interface with the server computer 115, the electronic devices 101, 102, 103 may actually interface with one or more of a number of distributed computers, servers, machines, or the like, to facilitate the described functionalities.

Although three (3) electronic devices 101, 102, 103, and one (1) server computer 115 are depicted in FIG. 1A, it should be appreciated that greater or fewer amounts are envisioned. For example, there may be multiple server computers, each one associated with a different entity. FIG. 1B depicts more specific components associated with the systems and methods.

FIG. 1B an example environment 150 in which input data 117 is processed into output data 151 via a time series forecasting platform 155, according to embodiments. The time series forecasting platform 155 may be implemented on any computing device or combination of computing devices, including the server computer 115 and/or any of the electronic devices 101, 102, 103, as discussed with respect to FIG. 1A. Components of the computing device may include, but are not limited to, a processing unit (e.g., processor(s) 156), a system memory (e.g., memory 157), and a system bus 158 that couples various system components including the memory 157 to the processor(s) 156. In some embodiments, the processor(s) 156 may include one or more parallel processing units capable of processing data in parallel with one another. The system bus 158 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The time series forecasting platform 155 may further include a user interface 153 configured to present content (e.g., input data, output data, processing data, and/or other information). Additionally, a user may review results of a time series forecasting analysis and make selections to the presented content via the user interface 153, such as to review output data presented thereon, make selections, and/or perform other interactions. The user interface 153 may be embodied as part of a touchscreen configured to sense touch interactions and gestures by the user. Although not shown, other system components communicatively coupled to the system bus 158 may include input devices such as cursor control device (e.g., a mouse, trackball, touch pad, etc.) and keyboard (not shown). A monitor or other type of display device may also be connected to the system bus 158 via an interface, such as a video interface. In addition to the monitor, computers may also include other peripheral output devices such as a printer, which may be connected through an output peripheral interface (not shown).

The memory 157 may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications (e.g., a time series forecasting application 160), data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor 156 of the computing device.

The time series forecasting platform 155 may operate in a networked environment and communicate with one or more remote platforms, such as a remote platform 165, via a network 162, such as a local area network (LAN), a wide area network (WAN), or other suitable network. The platform 165 may be implemented on any computing device, including any of the set of electronic devices 101, 102, 103 as discussed with respect to FIG. 1A, and may include many or all of the elements described above with respect to the platform 155. In some embodiments, the time series forecasting application 160 as will be further described herein may be stored and executed by the remote platform 165 instead of by or in addition to the platform 155.

Generally, each of the input data 117 and the output data 152 may be embodied as any type of electronic document, file, template, etc., that may include various graphical/visual and/or textual content, and may be stored in memory as program data in a hard disk drive, magnetic disk and/or optical disk drive in the time series forecasting platform 155 and/or the remote platform 165. The time series forecasting platform 155 may support one or more techniques, algorithms, or the like for analyzing the input data 117 to generate the output data 151. In particular, the time series forecasting application 160 may analyze various time series data to test and train machine learning models and/or generate a time series forecast using the trained machine learning models. The memory 157 may store the output data 151 and other data that the time series forecasting platform 155 generates or uses in associated with the analysis of the input data 117.

According to embodiments, the time series forecasting application 160 may various employ machine learning and artificial intelligence techniques such as, for example, a regression analysis (e.g., a logistic regression, linear regression, random forest regression, probit regression, or polynomial regression), classification analysis, k-nearest neighbors, decisions trees, random forests, boosting, neural networks, support vector machines, deep learning, reinforcement learning, Bayesian networks, or the like. When the input data 117 is a training dataset, the time series forecasting application 160 may analyze/process the input data 117 to generate and/or train a machine learning model(s) for storage as part of model data 163 that may be stored in the memory 157. In embodiments, various of the output data 151 may be added to the machine learning model stored as part of the model data 163. In analyzing or processing the input data 117, the time series forecasting application 160 may use any of the output data 151 previously generated by the time series forecasting platform 155.

The time series forecasting application 160 (or another component) may cause the output data 151 (and, in some cases, the training or input data 117) to be displayed on the user interface 153 for review by the user of the time series forecasting platform 155. Additionally, the time series forecasting application 160 may analyze or examine the output data 151 to assess any time series forecasts, which may be displayed on the user interface 153 as part of a dashboard, interface, or the like. The user may select to review and/or modify the displayed data. For instance, the user may review the output data 151 to assess opportunities for improving business operations.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 156 (e.g., working in connection with an operating systems) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML, R, Stata, AI libraries). In some embodiments, the computer program product may be part of a cloud network of resources.

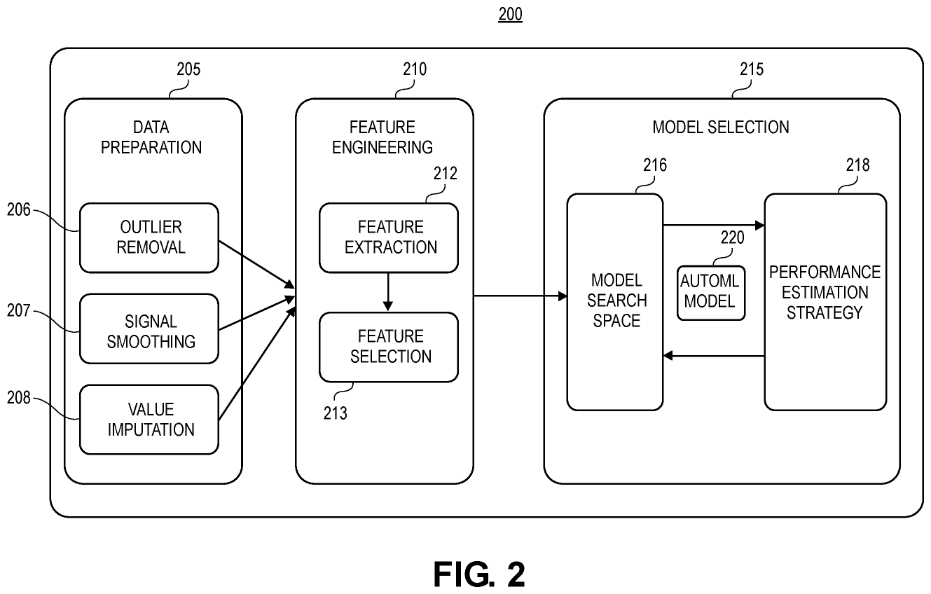

FIG. 2 illustrates an overview 200 of various features and functionalities of the systems and methods. The features and functionalities as illustrated in FIG. 2 may be performed by a computing device(s), such as the server computer 115 as discussed with respect to FIG. 1A or the time series forecasting platform 155 as discussed with respect to FIG. 1B. According to certain aspects, the systems and methods involve three stages: data preparation (205), feature engineering (210), and model selection (215).

In embodiments, the data preparation stage 205 may involve passing a set of time series data through up to three preparation and cleaning steps before features within the set of time series data are extracted and selected. In particular, the set of time series data is initially passed through an outlier removal technique 206 which may be configured to ensure that any impossible data or human error is not being fed into the model creation pipeline. Outliers may be initially detected by setting a threshold value for a maximum amount of standard deviation presented, and checking any data points that might be over that margin. Further, any lower and maximum bounds may be defined to make sure that all data points respect these ranges. In embodiments, a set of configurable techniques or combination of techniques may be selected to identify any outliers, including seasonal-trend decomposition using loess (STL), interquartile range (IQR), mean and standard deviation method, and/or another technique.

After the outlier detection is performed, any detected outlier can be replaced in one of two manners. First, a moving average may be calculated in which past values of the data are combined to infer the next plausible value of the current outlier data point. This technique may be simple and fast, but may face problems whenever the quality of the data is bad. Second, model regression may be used when there are too many missing values or a high number of outliers, where the data points may be replaced using a regression model to infer the plausible value at that stage. It should be appreciated that various regression models may be employed such as, for example, the time series model Prophet.

Additionally, a signal smoothing technique 207 may be performed on the set of time series data in order to remove any white noise that might exist or any unwanted abrupt change of variance that might impute errors on the forecasting model training. According to embodiments, the signal smoothing technique 207 may be performed in one or more ways. First, similar to the outlier replacement functionality, a moving average may be used to smooth out the overall signal and make abrupt variations less noticeable. However, this approach may oversimplify the signal, thus removing important features necessary for future forecasting. Second, an exponential moving average may be employed to apply weighting to the inputs that decreases exponentially the further away from the newest datapoint the weight is. Third, similar to the outlier replacement functionality, model imputation may be used to predict a plausible value for the next iteration, therefore reducing possible noise in the data. However, model imputation has the downside of incurring bias in the data, as using predicted values may cause the same model to perform artificially better than others during training.

Additionally, a value imputation technique 208 may be performed for data intervals that might be missing or have a “not-a-number” (NAN) value. The value imputation technique 208 is important because there are models that would present an error in training or converge to vanishing or exploding weights if there are missing values in the timeseries. The value imputation technique 208 may be performed in one or more ways. First, a moving average calculation may be used to impute missing or NAN datapoints in the data. However, this calculation does not work well if large intervals of time are missing. Second, a model regression may be employed in situations in which there is a large range of values where data is not available. However, the model regression may have the same problem as in the case of the signal smoothing technique 207, since if too many data points are replaced, bias in the model selection stage may result. It should be appreciated that, in addition or as an alternative to the imputation of numerical values, the systems and methods may impute a set of categorical values. In particular, the systems and methods may examine multiple columns and impute missing categorical values based on relationships between these categories.

In the feature engineering stage 210, relevant features may be extracted (212) and selected (213) from the set of time series data in order to create a feature vector that will later be used to determine the best model to be used for the time series data. In embodiments, various features may be extracted and used for the model selection stage 215, including at least entropy, linearity, trend strength, seasonality strength, instability, and/or lumpiness.

According to embodiments, the entropy of the set of time series data (i.e., approximate entropy) may be extracted and used to quantify the amount of regularity and unpredictability of the set of time series data. Generally, values with high entropy have a higher amount of irregularity than values with lower entropy.

Further, linearity data may be extracted and used to measure how linear the corresponding set of time series data is, where this measurement may be calculated by using a linear regression estimation and checking the quality of the fitting. Generally, high values of linearity means that the set of time series data is more prone to have a linear trend.

Additionally, trend strength data may be extracted from the set of time series data, where the trend is a component of a time series that represents low frequency variation of data, which may present as a tendency of data to behave in a certain way. The trend strength may measure how well this tendency is maintained throughout the progression of time. Generally, high trend strength means a more stable fixation to the tendency.

Further still, seasonality strength data may be extracted from the set of time series data, where the seasonality of a time series is when similar patterns of value variations happen at fixed time intervals, and where the strength of that seasonality may measure how reliable this variation is towards the progression of the time series and how much this measurement may be used to explain non-trend noise. Generally, high seasonality indicates a bigger continuity of the same patterns.

Additionally, instability data may be extracted from the set of time series data, where the instability of a signal is a measurement that may be obtained after the data has been normalized, and where it may provide a perspective on how the mean changes over time. Generally, low instability means that the time series has a more constant, less varying mean.

Moreover, lumpiness data may be extracted from the set of time series data, where lumpiness may refer to a pattern where the magnitude of observations varies greatly depending on the time period. Specifically, the lumpiness may refer to the tendency for large values to cluster together in time, creating “lumps” or clusters of high or low values. Generally, high lumpiness means that the data has high variance, projecting a more unstable characteristic onto the signal.

According to embodiments, each of these extracted features may represent a set of behaviors and/or characteristics that are used for the training and the subsequent inference by one or more machine learning models. The total conjunction of these measurements may represent a snapshot of the overall measurable behavior of a set of time series data, which may also be used for distinguishing inputs during training of the AutoML model underlying the stages 205, 210, and 215 FIG. 2. These measurements generally represent independent values with few relationships between each other, however these described features and measurements thereof are not exhaustive, and additional or alternative features and prediction parameters are envisioned.

After all the features are extracted from the signal, thus creating a feature vector representing the major characteristics of the set of time series data, the model selection stage 215 may be performed. In embodiments, model selection may be performed by a trained classifier model that may take the feature vector as an input and determine the best machine learning model, among a set of machine learning models included in a model search space 216, to be used for further time series data analysis.

According to embodiments, various types and amounts of machine learning models included in the model search space 216 are envisioned for time series forecasting. It should be appreciated that the model search space 216 may be configured in a modular manner which may enable for the inclusion or removal of one or more models in the model search space 216, for example manually by a user or automatically based on one or more characteristics. For instance, the Seasonal Autoregressive Integrated Moving Average (SARIMA) model is derived from the combination of using autoregressive (AR) and moving average (MA) features to predict data that can present both trends and seasonality. Generally, the SARIMA model accounts for various components including seasonality, trend, stationarity, and integration. Further, the Trigonometric, Box-cox transformation, AutoRegressive Moving Average, Trend components, and Seasonality (TBATS) model is used for complex time series that exhibit multiple seasonality and trend shifts.

Further still, an exponential smoothing model is a type of forecast prediction model that uses an exponential moving average to predict the value of the next data point. Generally, this model has two types of variation: single exponential smoothing used for signal smoothing techniques and is usually applied for stationary signals, and double exponential smoothing which is a recursive application of exponential smoothing in the case where there is a trend in the data.

Additionally, the Prophet model is used to forecast univariate time series data based on an additive model where non-linear trends are fit with yearly, weekly, and daily seasonality, as well as holiday effects. Further, the long short-term memory (LTSM) model is a type of recurrent neural network (RNN) that is designed to capture long-term dependencies in data, and may be well-suited for modeling complex temporal patterns.

Further still, the Neural Basis Expansion Analysis for Interpretable Time Series Forecasting (NBEATS) is a neural network architecture that is designed to be a flexible and interpretable model that can capture complex temporal patterns in the data. Moreover, the NeuralProphet model combines the simplicity and interpretability of Prophet with the flexibility and accuracy of neural networks.

Generally, these time series forecasting models may be trained on historical data and used to forecast future values. It should be appreciated that alternative and/or additional machine learning models for time series forecasting are envisioned.

According to embodiments, a performance estimation strategy component 218 may train and test each machine learning model included in the model search space 216 with a set of training time series data and a set of testing time series data, respectively. In particular, the set of training time series data and the set of testing time series data may be extracted from various sources and encompass various segment areas, such as to ensure that each machine learning model has a diverse set of bias and seasonality in its inputs.

In embodiments, each of the set of training time series data and the set of testing time series data may be segmented according to various time intervals. For example, the various time intervals may be monthly, daily, hourly, and/or other time intervals. Generally, monthly time series data (or otherwise data with a long time interval) is intended to capture the behavior of largely-spaced time series while being relevant and used across a wide variety of applications. Further, the accumulation factor resulting from the large time difference between data points increases the difficulty for forecasting, making it a challenge for most models. Additionally, daily time series data (or otherwise data with an intermediate time interval) provides a balance of strong seasonality and also a high number of samples to be trained upon. Further, hourly time series data (or otherwise data with a short time interval) provides the challenge of having multiple trends and seasonality, while also having usually large amounts of training data.

Initially, each machine learning model may be trained and tested for each time series in the dataset. That is, for a given machine learning model A, machine learning model B, a set of training time series data that is segmented into monthly, daily, and hourly series, and a set of testing time series data that is also segmented into monthly, daily, and hourly series, each of models A and B is trained using the monthly training time series data, the daily training time series data, and the hourly training time series data. Further each of the trained models A and B is tested using the monthly testing time series data, the daily testing time series data, and the hourly testing time series data. It should be appreciated that time series data may be segmented into alternative or additional time periods (e.g., multiple hours, fifteen (15) minutes, each minute, each second, etc.).

Each test may generate a weighted mean absolute percentage error (WMAPE) score for each time series for each machine learning model, where each WMAPE score may be normalized according to the highest WMAPE score for that specific time series input. The score vector therefore may have a maximum score of one (1) and a minimum score of zero (0) (although in certain implementations there is no theoretical maximum value for WMAPE). Because the lower the WMAPE the better the model, the lowest scores in each time series input may be chosen as the true label for that particular data point, thus creating the class labels distribution that would be used in training and testing. It should be appreciated that alternative or additional techniques may be used to assess the performance of the machine learning models included in the model search space 216. In particular, although the use of WMAPE is described, it should be appreciated that additional or alternative metrics or techniques for testing the time series data are envisioned (e.g., mean absolute error (MAE), root mean squared error (RMSE), symmetric mean absolute percentage error (SMAPE), and/or others). An AutoML model component 220 may be configured to select a machine learning model from the model search space 216 for analysis of a given set of time series data according to the testing performed by the performance estimation strategy component 218 as well as a set of features contained in the given set of time series data.

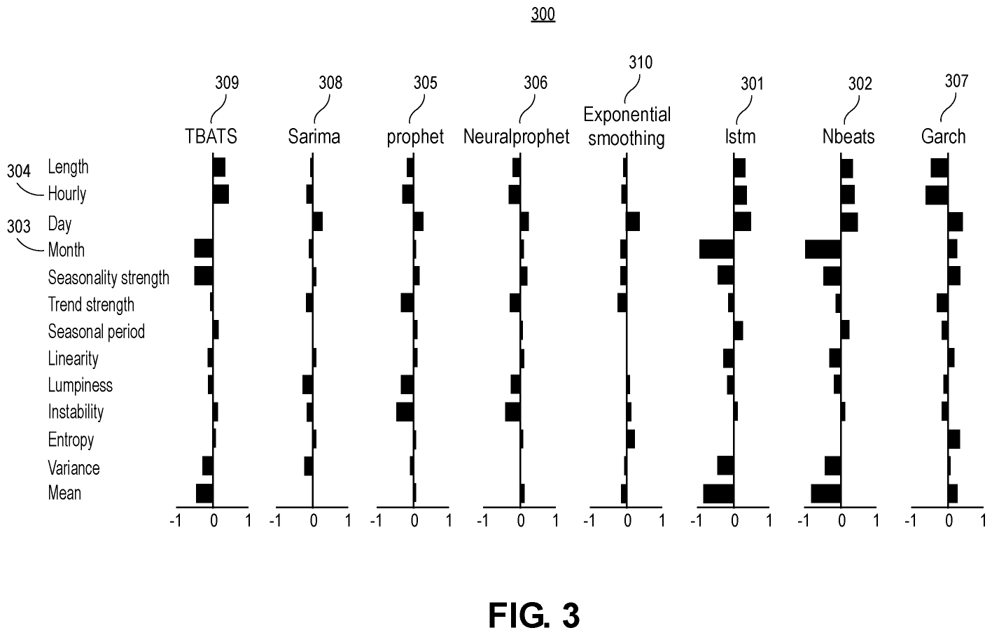

FIG. 3 is a correlation table 300 illustrating that the results of the testing performed by the performance estimation strategy component 218 result in the machine learning models having different performances based on the features and types of the time series data. Generally, the individual performance scores may be on a scale from −1 to 1, where a higher performance score (i.e., a positive score from 0 to 1) may indicate that a corresponding machine learning model would achieve higher forecasting accuracy for that associated feature/time of time series data; and a lower performance score (i.e., a negative score from 0 to −1) may indicate that a corresponding machine learning model would achieve lower forecasting accuracy for that associated feature/time of time series data. As illustrated in the correlation table 300, each machine learning model may have at least one situation (i.e., characteristics, type, and/or amount of input time series data) in which that machine learning model would achieve the highest accuracy in forecasting results, thus demonstrating the diversity of different characteristics that exist in time series data.

The correlation table 300 illustrates various patterns and results related to certain machine learning models and types of inputted time series data. For instance, for deep learning models such as LSTM (301) and Nbeats (302), where a larger amount of input data is needed for improved results, monthly data (303, which usually has a small number of samples) performs poorly in comparison to the other models. However, those same deep learning models 301, 302 are better at hourly data (304) and longer seasonality data than most, if not all, of the other depicted machine learning models. Further, the correlation table 300 illustrates some relationships between the Prophet (305) and the Neural Prophet (306) models, as one is inspired by the other. Additionally, Garch (307), which is a machine learning model that performs well for short and unstable input data, has a positive correlation link with monthly time series data (303), which is usually more unstable due to the cumulative nature of the values. Further, there may be a correlation between linear models such as SARIMA (308) and TBATS (309, which also use ARMA errors inside), which may be linked to the same type of data characteristics. Finally, exponential smoothing (310) is a machine learning model that seems to work reasonably well for various types of time series characteristics, as illustrated by the high concentration of top-1 labels for this kind of model.

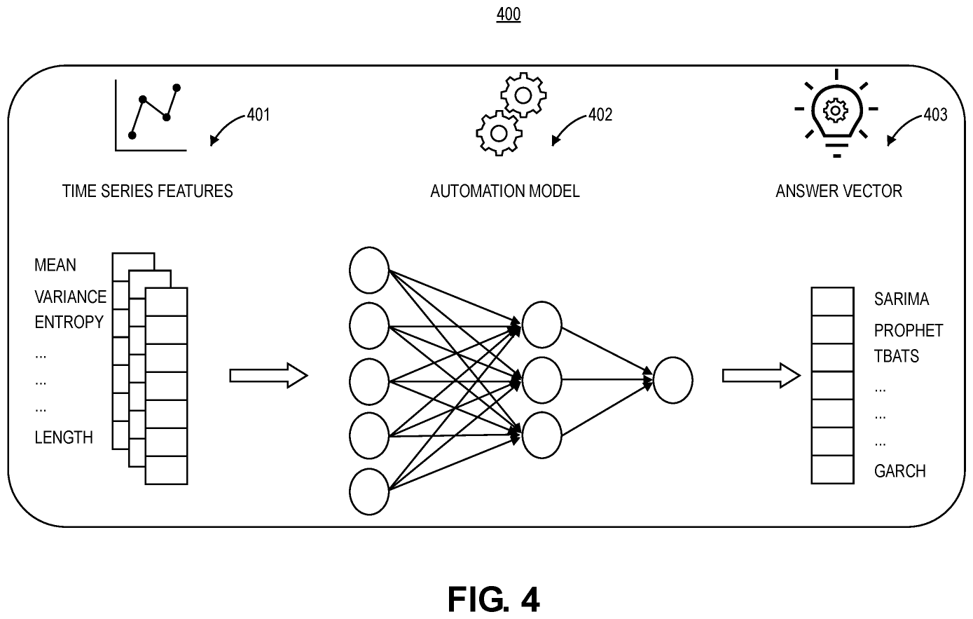

FIG. 4 depicts a diagram 400 illustrating functionalities associated with using the trained AutoML model 220 of FIG. 2. In particular, the systems and methods may use the feature vector extracted from the time series data (401; as described with respect to FIG. 2) as inputs, the vector of results from the different models as one-hot class labels, and an automation model 402 that would receive the inputs and classify them to match the correct vector label distribution (403). According to embodiments, the vector label distribution 403 represents the models in order based on performance. For example, as shown in the scenario of FIG. 4, SARIMA is the best performing model and GARCH is the worst performing model in association with analyzing the corresponding time series data. Generally, this functionality enables the examination of any features of the time series data, and the outputting of an ordered list of models without having to individually train the models using the raw time series data.

Various types of models for the automation model 402 may be used, each with different performance. In particular, the automation model 402 may be a neural network which may use a fully-connected perceptron layer with dropout and batch normalization; a weighted neural network where the values of the weights may calculated based on the total amount of labels for each class in the training samples; a boosted tree model such as, for example, XGboost that may be used as a multiclass classifier due to its speed and versatility; or a weighted boosted tree model such as, for example Weighted XGboost.

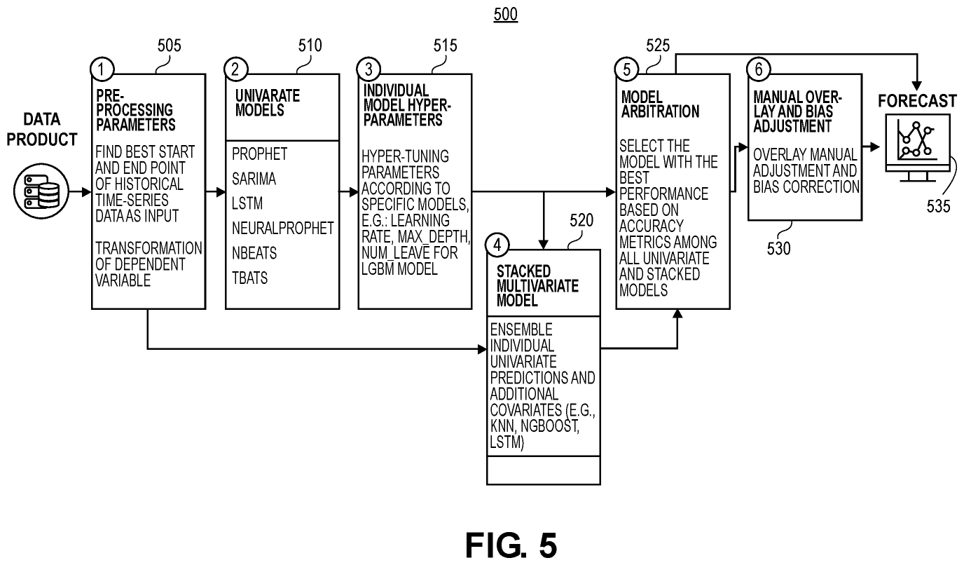

FIG. 5 is a diagram 500 illustrating an overview of the components and functionalities employed by the present embodiments to perform time series forecasting. The features and functionalities as illustrated in FIG. 5 may be performed by a computing device(s), such as the server computer 115 as discussed with respect to FIG. 1A or the time series forecasting platform 155 as discussed with respect to FIG. 1B

The diagram 500 indicates functionality for pre-processing parameters (505). In particular, the pre-processing parameters functionality 505 is configured to perform outlier removal, signal smoothing, and value imputation as discussed with respect to FIG. 2. Further, the pre-processing parameters functionality 505 may support a timeseries statistics report that provides useful information regarding the predictability of a time series dataset prior to forecasting. In embodiments, the time series statistics report may include the following measures, as described with respect to FIG. 2: entropy, linearity, trend strength, seasonality strength, instability, and lumpiness.

The diagram 500 further indicates a set of univariate models 510 including, as shown, Prophet, SARIMA, LSTM, NeuralProphet, NBEATS, and TBATS. It should be appreciated that alternative and additional univariate models are envisioned, as discussed herein. Generally, the Prophet model is effective with data that has many change points and outliners; the SARIMA model is effective with stationary data; the TBATS model is effective with complex seasonal interaction in data; the LSTM model is effective with large amounts of data and can capture historical and recent trends; the NBEATS model is effective with large amounts of data and can be faster than other neural networks; and the NeuralProphet model is effective with large amounts of data and combines benefits of the Prophet and other neural network models.

The diagram 500 further indicates functionality 515 associated with hyper tuning parameters according to specific models. According to embodiments, the functionality 515 may employ one or more tuning algorithms for the selection of model hyperparameters in order to minimize run-time. Generally, there may be hyperparameters that are specific to each of the set of univariate models 510. For example, hyperparameters for the LSTM univariate model include window size, batch size, and learning rate; hyperparameters for the Prophet univariate model include sensitivity to seasonality and sensitivity to trend changepoint; and hyperparameters for the SARIMA univariate model include various unique parameters regarding trend, seasonality, and differencing.

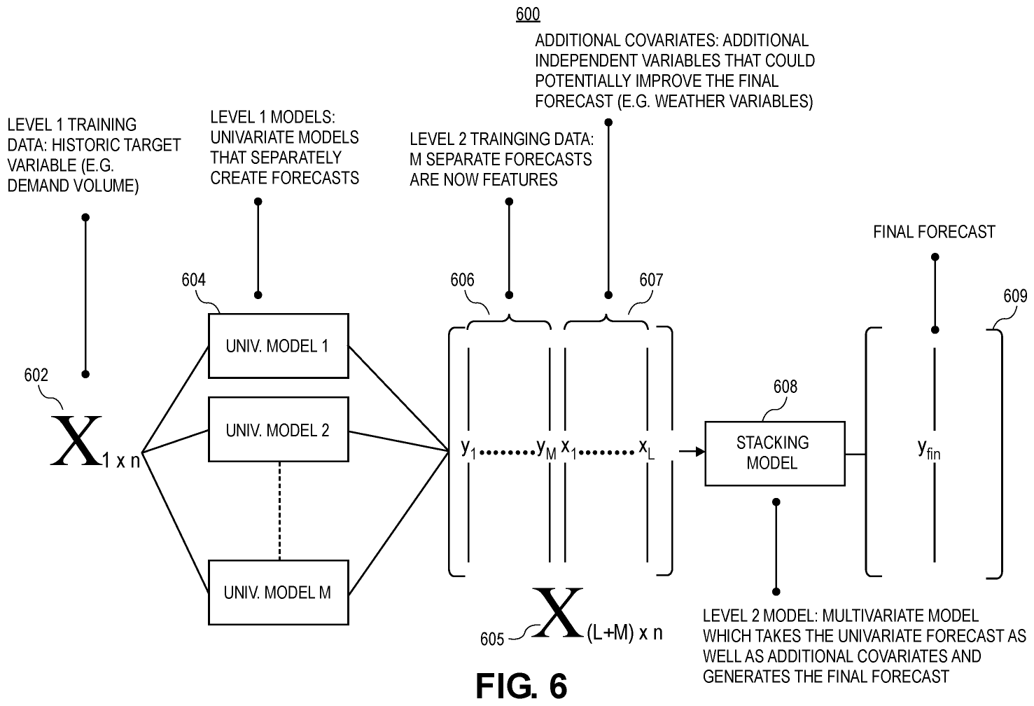

The diagram 500 further includes functionality 520 associated with a stacking model that incorporates the set of univariate models 510, such as to concurrently leverage the strengths of different univariate models and any applicable covariates. FIG. 6 illustrates a diagram 600 associated with the stacking functionality 520 referenced in FIG. 5.

As illustrated in FIG. 6, the diagram 600 indicates a set of training data 602 comprising a set of time series data along with a set of target values associated with a set of target variables. That is, the set of training data 602 may correspond to historical data of known results. The diagram 600 further indicates a set of univariate models 604 that may be independently trained, tested, and tuned, as discussed herein.

A set of respective outputs 606 of the set of univariate models 604 compose at least a part of a data matrix 605. According to embodiments, the data matrix 605 may further include a set of covariates 607 which may be additional variables that may potentially improve a final time series forecast. For example, the set of covariates 607 may be weather variables, day of the week, and/or other variables that may potentially affect a time series forecast.

The data matrix 605 and the data thereof may be used as an input to train a stacking model 608. In embodiments, the stacking model 608 may be trained on the data of the matrix 605 as well as on a set of final forecast data 609 (i.e., a set of historical data indicating known time series results). Thus, the stacking model 608 may be trained to account for which univariate model(s) or combinations of univariate models would work well with which types of input data and which types of covariates.

The stacking model 608 may be similarly used to analyze a set of input (i.e., non-training) time series data. In particular, the univariate models 604 may respectively output separate time series forecasts, which may be combined with any covariates to form a data matrix. This data matrix, in turn, may be input into the stacking model 608 which may output a final time series forecast that accounts for which of the univariate models 604 perform well in which contexts and/or according to the type of data included in the set of input time series data.

The diagram 500 of FIG. 5 further indicates a model arbitration functionality 525 that may be configured to select, among the univariate models 510 and the stacked model 520, the highest performing model(s). According to embodiments, each of the univariate models 510 and the stacked model 520 may be tested using a test set of time series data, where the outputs of each of the univariate models 510 and the stacked model 520 may be compared to a set of actual results corresponding to the test set of time series data, and where a performance score may be assigned to each of the univariate models 510 and the stacked model 520 based on the comparing. The model with the best performance score may be deemed as the model that is best equipped to analyze that particular test set of time series data., as well as predict the target value(s) for future time steps. Thus, the model with the best performance score may be deemed as the model that is best equipped to generate or determine the forecasted (i.e., predicted) future time series data.

The diagram 500 may further indicate a manual overlay and bias adjustment functionality 530 that may overlay any manual adjustment and/or bias correction on the forecast data that is output by the model with the best performance. In particular, the manual overlay and bias adjustment functionality 530 may employ various techniques to improve forecasting accuracy, such as spike adjustment to improve forecasts for outliers (e.g., holidays and special events), statistical downscaling to mitigate a consistent over-forecast or under-forecast model output, and/or other bias corrections to, for example, account for other factors contributing to forecast bias (e.g., weather).

A final time series forecast 535 may result, either directly from the model arbitration functionality 525 (i.e., the time series data that is output by the model with the best performance) or from the manual overlay and bias adjustment functionality 530. According to embodiments, the final time series forecast 535 may be accessed by a user via a computing device for use and assessment.

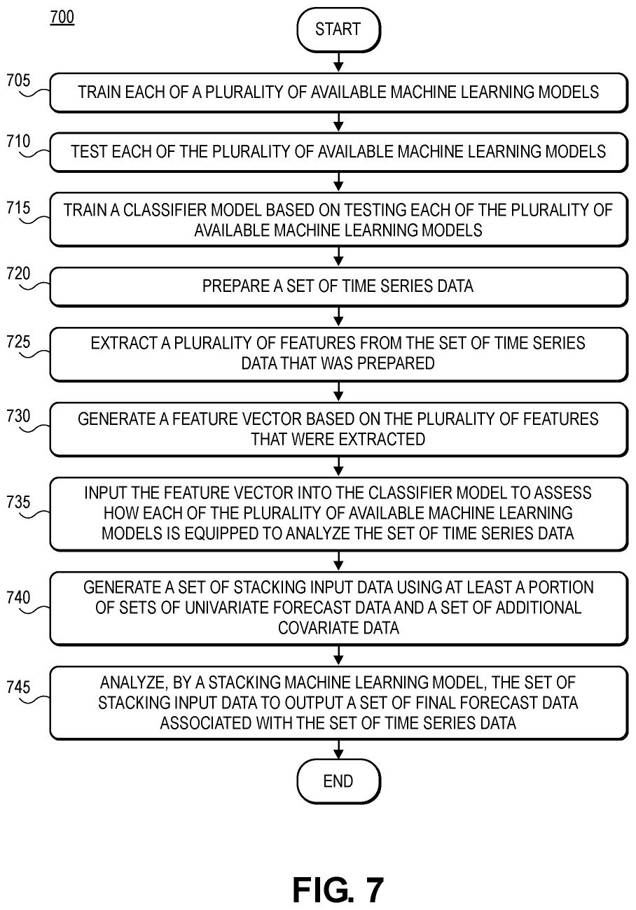

FIG. 7 depicts is a block diagram of an example method 700 of using machine learning for time series forecasting. The method 700 may be facilitated by an electronic device (such as the server computer 115 as depicted in FIG. 1A). In embodiments, the electronic device may communicate with a set of data sources and a set of additional electronic devices.

The method 700 may begin when the electronic device trains (block 705) each of a plurality of available machine learning models. Further, the electronic device may test (block 710) each of the plurality of available machine learning models. In embodiments, each of a set of time series training data and a set of time series testing data may be segmented according to multiple time intervals. Further, the electronic device may train each of the plurality of available machine learning models using the set of time series training data, for each of the multiple time intervals, and may test each of the plurality of available machine learning models that was trained using the set of time series testing data, for each of the multiple time intervals. Further, based on testing each of the plurality of available machine learning models, the electronic device may assess a performance of each of the plurality of available machine learning models, for each of the multiple time intervals.

The electronic device may train (block 715) a classifier model (i.e., an automated machine learning selection model) based on testing each of the plurality of available machine learning models. In embodiments, the performance of each of the plurality of available machine learning models, for each of the multiple time intervals, may be embodied as a vector of results that is labeled according to each performance. Further, the set of time series training data may have associated a training feature vector. In embodiments, the electronic device may train the classifier model using the training feature vector and the vector of results.

At block 720, the electronic device may prepare a set of time series data. In embodiments, the electronic device may prepare the set of time series data by performing an outlier removal technique, a signal smoothing technique, and/or a value imputation technique. At block 725, the electronic device may extract a plurality of features from the set of time series data that was prepared. In particular, the electronic device may extract at least one of: entropy, linearity, trend strength, seasonality strength, instability, or lumpiness. At block 730, the electronic device may generate a feature vector based on the plurality of features that were extracted.

At block 735, the electronic device may input the feature vector into the classifier mode to assess how well each of the plurality of available machine learning models is equipped to analyze the set of time series data. In particular, the electronic device may input the feature vector into the classifier model to evaluate a performance of each of the plurality of available machine learning models in time series forecasting the set of time series data.

According to embodiments, each of the plurality of available machine learning models has associated a set of training univariate forecast data. Further, the electronic device may generate a set of stacking training data using at least a portion of the sets of training univariate forecast data and a set of additional training covariate data, and train a stacking machine learning model using the set of stacking training data and a set of historical data indicating known time series results.

Further, according to embodiments, each of the plurality of available machine learning models may have associated a set of univariate forecast data associated with the set of time series data. At block 740, the electronic device may generate a set of stacking input data using at least a portion of sets of univariate forecast data and a set of additional covariate data. Further, at block 745, the electronic device may analyze, by the stacking machine learning model, the set of stacking input data to output a set of final forecast data associated with the set of time series data.

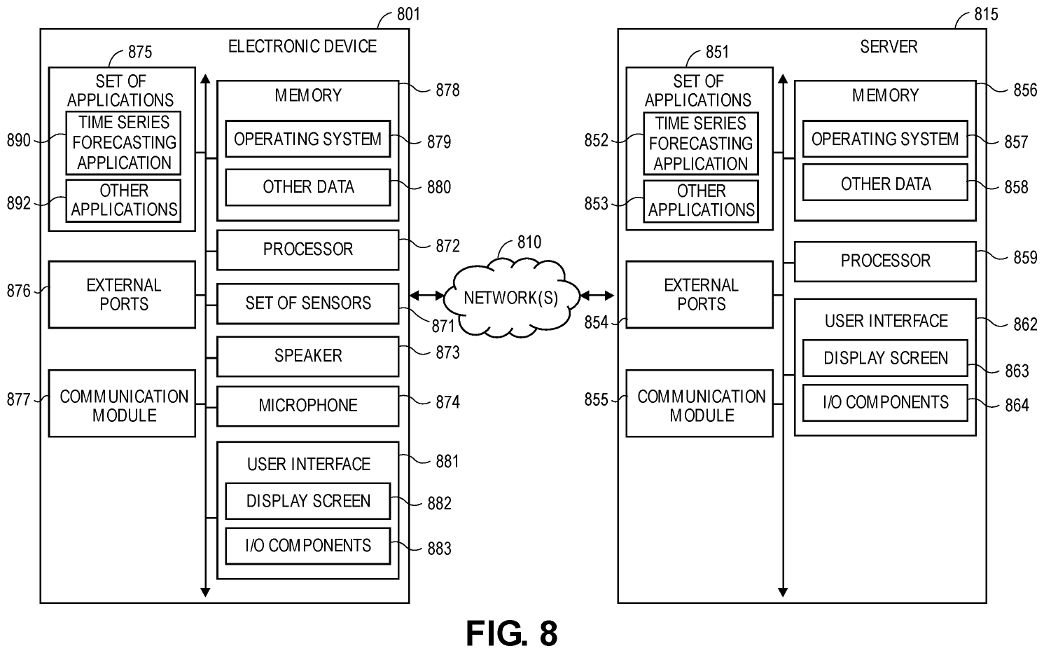

FIG. 8 illustrates a hardware diagram of an example electronic device 801 (e.g., one of the electronic devices 101, 102, 103 as described with respect to FIG. 1A) and an example server 815 (e.g., the server computer 115 as described with respect to FIG. 1A), in which the functionalities as discussed herein may be implemented. It should be appreciated that the components of the electronic device 801 and the server 815 are merely exemplary, and that additional or alternative components and arrangements thereof are envisioned.

The electronic device 801 may include a processor 872 as well as a memory 878. The memory 878 may store an operating system 879 capable of facilitating the functionalities as discussed herein as well as a set of applications 875 (i.e., machine readable instructions). For example, one of the set of applications 875 may be a time series forecasting application 890, such as to access various data, train and test machine learning models, and analyze data using the machine learning models. It should be appreciated that one or more other applications 892 are envisioned.

The processor 872 may interface with the memory 878 to execute the operating system 879 and the set of applications 875. According to some embodiments, the memory 878 may also store other data 880, such as machine learning model data and/or other data such time series data that may be used in the analyses and determinations as discussed herein. The memory 878 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 801 may further include a communication module 877 configured to communicate data via one or more networks 810. According to some embodiments, the communication module 877 may include one or more transceivers (e.g., WAN, WWAN, WLAN, and/or WPAN transceivers) functioning in accordance with IEEE standards, 3GPP standards, or other standards, and configured to receive and transmit data via one or more external ports 876.

The electronic device 801 may include a set of sensors 871 such as, for example, a location module (e.g., a GPS chip), an image sensor, an accelerometer, a clock, a gyroscope (i.e., an angular rate sensor), a compass, a yaw rate sensor, a tilt sensor, telematics sensors, and/or other sensors. The electronic device 801 may further include a user interface 881 configured to present information to a user and/or receive inputs from the user. As shown in FIG. 8, the user interface 881 may include a display screen 882 and I/O components 883 (e.g., ports, capacitive or resistive touch sensitive input panels, keys, buttons, lights, LEDs, and/or built in or external keyboard). Additionally, the electronic device 801 may include a speaker 873 configured to output audio data and a microphone 874 configured to detect audio.

In some embodiments, the electronic device 801 may perform the functionalities as discussed herein as part of a “cloud” network or may otherwise communicate with other hardware or software components within the cloud to send, retrieve, or otherwise analyze data.

As illustrated in FIG. 8, the electronic device 801 may communicate and interface with the server 815 via the network(s) 810. The server 815 may include a processor 859 as well as a memory 856. The memory 856 may store an operating system 857 capable of facilitating the functionalities as discussed herein as well as a set of applications 851 (i.e., machine readable instructions). For example, one of the set of applications 851 may be time series forecasting application 852, such as to access various data, train and test machine learning models, and analyze data using the machine learning models. It should be appreciated that one or more other applications 853 are envisioned.

The processor 859 may interface with the memory 856 to execute the operating system 857 and the set of applications 851. According to some embodiments, the memory 856 may also store other data 858, such as machine learning model data and/or other data such as time series data that may be used in the analyses and determinations as discussed herein. The memory 856 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 815 may further include a communication module 855 configured to communicate data via the one or more networks 810. According to some embodiments, the communication module 855 may include one or more transceivers (e.g., WAN, WWAN, WLAN, and/or WPAN transceivers) functioning in accordance with IEEE standards, 3GPP standards, or other standards, and configured to receive and transmit data via one or more external ports 854.

The server 815 may further include a user interface 862 configured to present information to a user and/or receive inputs from the user. As shown in FIG. 8, the user interface 862 may include a display screen 863 and I/O components 864 (e.g., ports, capacitive or resistive touch sensitive input panels, keys, buttons, lights, LEDs, external or built in keyboard). According to some embodiments, the user may access the server 815 via the user interface 862 to review information, make selections, and/or perform other functions.

In some embodiments, the server 815 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processors 872, 859 (e.g., working in connection with the respective operating systems 879, 857) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

1. A computer-implemented method of using machine learning for time series forecasting, the computer-implemented method comprising:
accessing, by one or more processors, a set of time series training data and a set of time series testing data, wherein each of the set of time series training data and the set of time series testing data is segmented into multiple time intervals;
training, by the one or more processors for each of the multiple time intervals, each of a plurality of available machine learning models using the set of time series training data;
testing, by the one or more processors for each of the multiple time intervals, each of the plurality of available machine learning models that was trained using the set of time series testing data, wherein each of the plurality of available machine learning models that was trained and tested is configured to perform a time series data analysis on time series data;
based on testing each of the plurality of available machine learning models, assessing a time series forecasting accuracy metric of each of the plurality of available machine learning models, for each of the multiple time intervals, wherein the time series forecasting accuracy metric of each of the plurality of available machine learning models, for each of the multiple time intervals, is embodied as a vector of results that is labeled according to each time series forecasting accuracy metric;
preparing, by one or more processors, a set of time series data;
extracting, by the one or more processors, a plurality of features from the set of time series data that was prepared;
generating, by the one or more processors, a feature vector based on the plurality of features that were extracted; and
inputting, by the one or more processors into a classifier model, the feature vector labeled according to the vector of results, wherein the classifier model outputs a performance score for each of the plurality of available machine learning models, wherein the performance score indicates an ability of that available machine learning model to accurately predict future time series data associated with the set of time series data.

2. The computer-implemented method of claim 1, wherein preparing the set of time series data comprises:
performing, on the set of time series data by the one or more processors, (i) an outlier removal technique, (ii) a signal smoothing technique, and (iii) a value imputation technique.

3. The computer-implemented method of claim 1, wherein extracting the plurality of features from the set of time series data that was prepared comprises:
extracting, by the one or more processors from the set of time series data that was prepared, at least one of: entropy, linearity, trend strength, seasonality strength, instability, or lumpiness.

4. (canceled)

5. The computer-implemented method of claim 1, wherein each of the plurality of available machine learning models has associated a set of univariate forecast data associated with the set of time series data, and wherein the computer-implemented method further comprises:
generating, by the one or more processors, a set of stacking input data using at least a portion of the sets of univariate forecast data and a set of additional covariate data; and
analyzing, by a stacking machine learning model, the set of stacking input data to output a set of final forecast data associated with the set of time series data.

6. The computer-implemented method of claim 5, wherein each of the plurality of available machine learning models has associated a set of training univariate forecast data, and wherein the computer-implemented method further comprises:
generating, by the one or more processors, a set of stacking training data using at least a portion of the sets of training univariate forecast data and a set of additional training covariate data; and
training, by the one or more processors, the stacking machine learning model using the set of stacking training data and a set of historical data indicating known time series results.

7. (canceled)

8. The computer-implemented method of claim 1, wherein the set of time series training data has associated a training feature vector, and wherein the computer-implemented method further comprises:
training, by the one or more processors, the classifier model using the training feature vector and the vector of results.

9. A system for using machine learning for time series forecasting, comprising:
a memory storing a set of computer-readable instructions and data associated with a classifier model and a plurality of available machine learning models; and
one or more processors interfaced with the memory, and configured to execute the set of computer-readable instructions to cause the one or more processors to:
access a set of time series training data and a set of time series testing data, wherein each of the set of time series training data and the set of time series testing data is segmented into multiple time intervals,
train, for each of the multiple time intervals, each of the plurality of available machine learning models using the set of time series training data,
test, for each of the multiple time intervals, each of the plurality of available machine learning models that was trained using the set of time series testing data, wherein each of the plurality of available machine learning models that was trained and tested is configured to perform a time series data analysis on time series data,
based on testing each of the plurality of available machine learning models, assess a time series forecasting accuracy metric of each of the plurality of available machine learning models, for each of the multiple time intervals, wherein the time series forecasting accuracy metric of each of the plurality of available machine learning models, for each of the multiple time intervals, is embodied as a vector of results that is labeled according to each time series forecasting accuracy metric,
prepare a set of time series data,
extract a plurality of features from the set of time series data that was prepared,
generate a feature vector based on the plurality of features that were extracted, and
input, into a classifier model, the feature vector labeled according to the vector of results, wherein the classifier model outputs a performance score for each of the plurality of available machine learning models, wherein the performance score indicates an ability of that available machine learning model to accurately predict future time series data associated with the set of time series data.

10. The system of claim 9, wherein to prepare the set of time series data, the one or more processors is configured to:
perform, on the set of time series data, (i) an outlier removal technique, (ii) a signal smoothing technique, and (iii) a value imputation technique.

11. The system of claim 9, wherein to extract the plurality of features from the set of time series data that was prepared, the one or more processors is configured to:
extract, from the set of time series data that was prepared, at least one of: entropy, linearity, trend strength, seasonality strength, instability, or lumpiness.

12. (canceled)

13. The system of claim 9, wherein each of the plurality of available machine learning models has associated a set of univariate forecast data associated with the set of time series data, and wherein the one or more processors is further configured to:
generate a set of stacking input data using at least a portion of the sets of univariate forecast data and a set of additional covariate data, and
analyze, by a stacking machine learning model, the set of stacking input data to output a set of final forecast data associated with the set of time series data.

14. The system of claim 13, wherein each of the plurality of available machine learning models has associated a set of training univariate forecast data, and wherein the one or more processors is further configured to:
generate a set of stacking training data using at least a portion of the sets of training univariate forecast data and a set of additional training covariate data, and
train the stacking machine learning model using the set of stacking training data and a set of historical data indicating known time series results.

15. (canceled)

16. The system of claim 9, wherein the set of time series training data has associated a training feature vector, and wherein the one or more processors is further configured to:
train the classifier model using the training feature vector and the vector of results.

17. A non-transitory computer-readable storage medium configured to store instructions executable by one or more processors, the instructions comprising:
instructions for accessing a set of time series training data and a set of time series testing data, wherein each of the set of time series training data and the set of time series testing data is segmented into multiple time intervals;
instructions for training, for each of the multiple time intervals, each of a plurality of available machine learning models using the set of time series training data;
instructions for testing, for each of the multiple time intervals, each of the plurality of available machine learning models that was trained using the set of time series testing data, wherein each of the plurality of available machine learning models that was trained and tested is configured to perform a time series data analysis on time series data;
instructions for, based on testing each of the plurality of available machine learning models, assessing a time series forecasting accuracy metric of each of the plurality of available machine learning models, for each of the multiple time intervals, wherein the time series forecasting accuracy metric of each of the plurality of available machine learning models, for each of the multiple time intervals, is embodied as a vector of results that is labeled according to each time series forecasting accuracy metric;
instructions for preparing a set of time series data;
instructions for extracting a plurality of features from the set of time series data that was prepared;
instructions for generating a feature vector based on the plurality of features that were extracted; and
instructions for inputting, into a classifier model, the feature vector labeled according to the vector of results, wherein the classifier model outputs a performance score for each of the plurality of available machine learning models, wherein the performance score indicates an ability of that available machine learning model to accurately predict future time series data associated with the set of time series data.

18. (canceled)

19. The non-transitory computer-readable storage medium of claim 17, wherein each of the plurality of available machine learning models has associated a set of univariate forecast data associated with the set of time series data, and wherein the instructions further comprise:
instructions for generating a set of stacking input data using at least a portion of the sets of univariate forecast data and a set of additional covariate data; and
instructions for analyzing, by a stacking machine learning model, the set of stacking input data to output a set of final forecast data associated with the set of time series data.

20. (canceled)
